(19) United States
(12) Patent Application Publication
(10) Pub. No.: US 2014/0115029 A1
(43) Pub. Date: Apr. 24, 2014

(54) SELECTIVE DATA TRANSFER BETWEEN A SERVER AND CLIENT

(71) Applicant: INTERNATIONAL BUSINESS MACHINES CORPORATION, Armonk, NY (US)

(72) Inventors: Duane M. Baldwin, Mantorville, MN (US); Sandeep R. Patil, Pune (IN); Riyazahamad M. Shiraguppi, Pune (IN); Divyank Shukla, Pune (IN)

(73) Assignee: International Business Machines Corporation, Armonk, NY (US)

(21) Appl. No.: 13/654,637

(22) Filed: Oct. 18, 2012

(51) Int. Cl. G06F 15/16

(52) U.S. Cl. 709/203

(57) ABSTRACT

A method and apparatus for transferring a file from a server to a client in sections is disclosed. In one embodiment, a method includes a server receiving a request from a client for a file. The file has a first section and second section. Each section, respectively, has a first security level and a second security level. A determination of a security protocol for transmission of each file section is determined using classification information and a template. The file sections are transmitted over a channel between the server and the client using the respective first security protocol and second security protocol.

### TECHNICAL FIELD

This disclosure generally relates to the transfer of data, and more specifically to the secure transfer between a server and a client of file information having more than one security level.

### BACKGROUND

Data processing systems are frequently comprised of a plurality of client platforms, such as personal workstations or personal computers, connected through networks to one or more server platforms, which provide data related services to the application programs executing on the client platforms. The data related services may include data storage and retrieval, data protection, and electronic mail services. These services may be provided to the users from both local servers, and from remote servers networked to a client's local server.

### SUMMARY

In one embodiment, a method is provided for transferring a file between a server and client in sections using multiple security protocols. The method includes a server receiving a request from a client for a file. The file may have a first section and second section. Each section may have a respective security level. The method further includes a determination of a security protocol for transmission of each file section using classification information and a template. The file sections may be transmitted over a channel between the server and the client using the respective first security protocol and second security protocol.

In another embodiment, an apparatus is provided for transferring a file between a server and client in sections using multiple security protocols. The apparatus includes storage to store a file. The file may have a first section and second section with a respective first security level and second security level. The first and second file sections may be associated with respective classification information. The apparatus may further include a server adapted to transmit the file from the storage to a client using a first security protocol for the first file section and a second security protocol for the second file section. The first and second security protocols may be selected based on a template and the respective associated classification information.

Yet another embodiment is directed to a computer-readable storage medium.

### BRIEF DESCRIPTION OF THE DRAWINGS

FIG. 1 depicts a high-level block diagram of an exemplary system according to an embodiment of the invention.

FIG. 2 is a functional overview diagram of an embodiment of the present invention.

FIG. 3 is a flowchart of a method for transferring a file between a server and a client, in accordance with an embodiment of the present invention.

In the Figures and the Detailed Description, like numbers refer to like elements.

### DETAILED DESCRIPTION

A client request for retrieving a file from a server may result in file-server logic having a storage manager gather the file from where it has been stored. Some files may be broken up into various sections stored in different locations. For example, a mixed security file may have the low security sections stored on remote disk storage or remote cloud storage. The high security sections of the file may be stored locally or on remote disk storage that is known to be highly secure. The file-server logic may use classification information, for example meta-data, available about the individual file sections to determine where and how the storage manager stores the individual file sections. The file-server logic may make limited use of the classification information when sending the file to the requesting client. The file-server logic may either look for an overall file security protocol, for example, in the file's extended attributes, or may base the entire file's security protocol off of the highest security section.

This means, for example, that a 10 mega-byte (MB) file that contains only 2 MB of data that requires high security may result in the server sending the entire 10 MB file using a high security protocol to the client. Thus, security protocols may require greater resource use as the security level of the transported data increases. For example, encryption of data may result in a great increase in the size and amount of data transmitted to the receiving entity. Encryption may also result in greater resource use as computing power, including CPU and memory use, is required for the encryption and de-encryption of the data at the server and client. The security protocol may also use additional resources, thus resulting in delays due to queing and bandwidth limitations, when they require transmittal over specific paths due to integrity concerns.

In contrast in one embodiment of the invention, the server uses the file section's classification information along with a new element, a “template”, to send the file in sections using different security protocols to the requesting client. This means that the same 10 MB file, that has only 2 MB of data that have high security requirements, may be transmitted from server to client with the overhead of the high security protocol being applied only to 2 MB of the transmitted data.

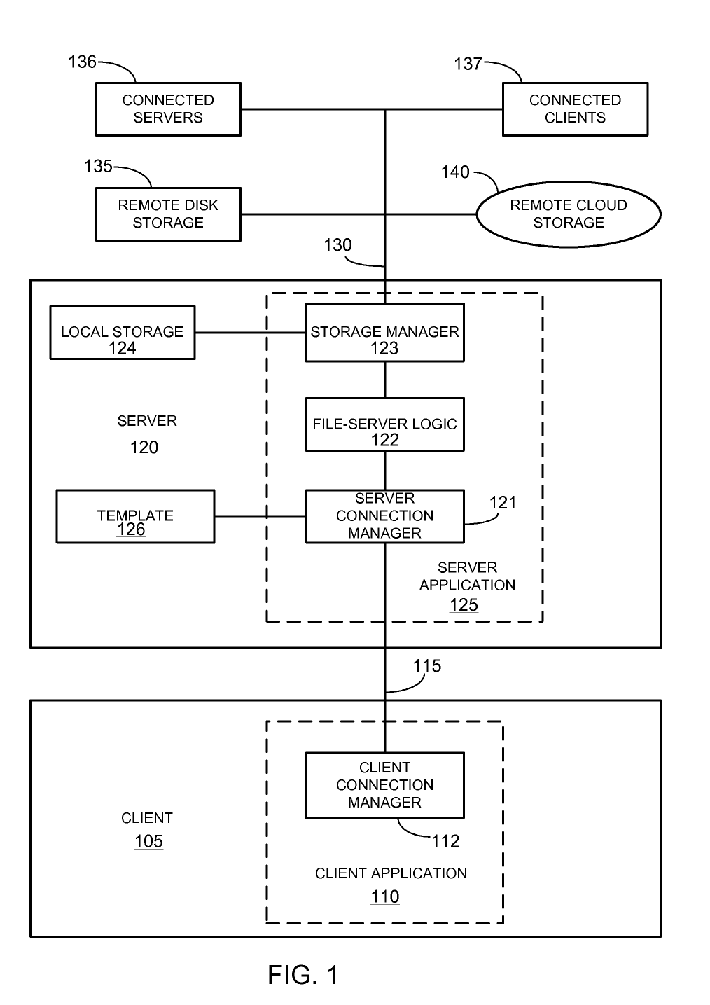

FIG. 1 depicts a high-level block diagram representation of a server 120 and a client 105 coupled via a channel 115, according to an embodiment. The server 120 may contain a storage manager 123. The storage manager 123 may access and maintain files available to the server 120. These files may be kept, in whole or in parts, in various storage mediums available to the server 120, including: local storage 124, remote disk storage 135, connected servers 136, connected clients 137, or cloud storage 140. Working with the storage manager 123 is a file-server logic 122. The file-server logic 122 maintains the file system and processes client requests that are made to it via a server connection manager 121. The server connection manager 121 may be connected to a client 105 by a channel 115. The server connection manager 121 manages channels of communication, for example, network connections made with client 105. In the illustrated example, the server connection manager 121, file-server logic 122, and storage manager 123 are all part of a single server application 125 run by the server 120. In other embodiments, they may be individual server applications 125 or grouped in combinations or parts of other applications run on the server 120.

The client 105 is an electronic system that accesses a service made available by a server 120. There are many types of clients and differences between the types of clients 105 are based typically based upon the amount of computational workload and data storage each client shares with a server 120 or servers, and may vary depending on the processing power and memory a client 105 contains. The client 105 may have a client application 110 that is used by an operator. A client application 110 typically is computer software designed to help the user to perform specific tasks. Examples of client application 110 may include enterprise software, accounting software, office suites, graphic software, and media players. Typically these client applications 110 may require a file from a connected server 120.

If the client application 110 is designed to use data or files outside of the application itself, it may include a client connection manager 112. The client connection manager 112 may create connections, define protocols and standards, and monitor and maintain such connections for the client 105 to create and sustain communication channels, such as channel 115, with servers, for example server 120, other clients, and various devices that may communicate with the client. The client connection manager 112 may be capable of performing all connection related tasks, or it may work with and use client connection capabilities of other applications on the client, for example, the connection manager capabilities of the operating system running on the client.

In one embodiment, the server 120 may use the classification information available for the individual file sections to transmit the sections of the file over two or more security protocols to the client 105. The classification information may include information on the security levels of the respective file sections. In various embodiments, the classification information for the file sections may be found, for example: on a database or table accessible to the server, the file header or allocated section of the file, or within the meta-data of the file sections. The file-server logic 122 or connection manager 121 may use the classification information in combination with a template 126 to transmit the file in sections using two or more security protocols for the various sections of the file. The template 126 may be available to the server 120, such as stored within the server's local memory, or it may provided by the client 105 to the server 120 with the file request or any time prior to the transmission of the file from server 120 to client 105. The client 105 may have a copy of the template 126 or an understanding of the template 126 such that it may assemble the sections of the file sent by the server 120 to the client 105. For example, the client connection manager 112 may provide the template to the server 120 and thus use the template to reassemble the sections of the transmitted file. In other embodiments, the template 126 may be used or provided by other elements within the client 105, such as security software that monitors and oversees communication between the server 120 and client 105.

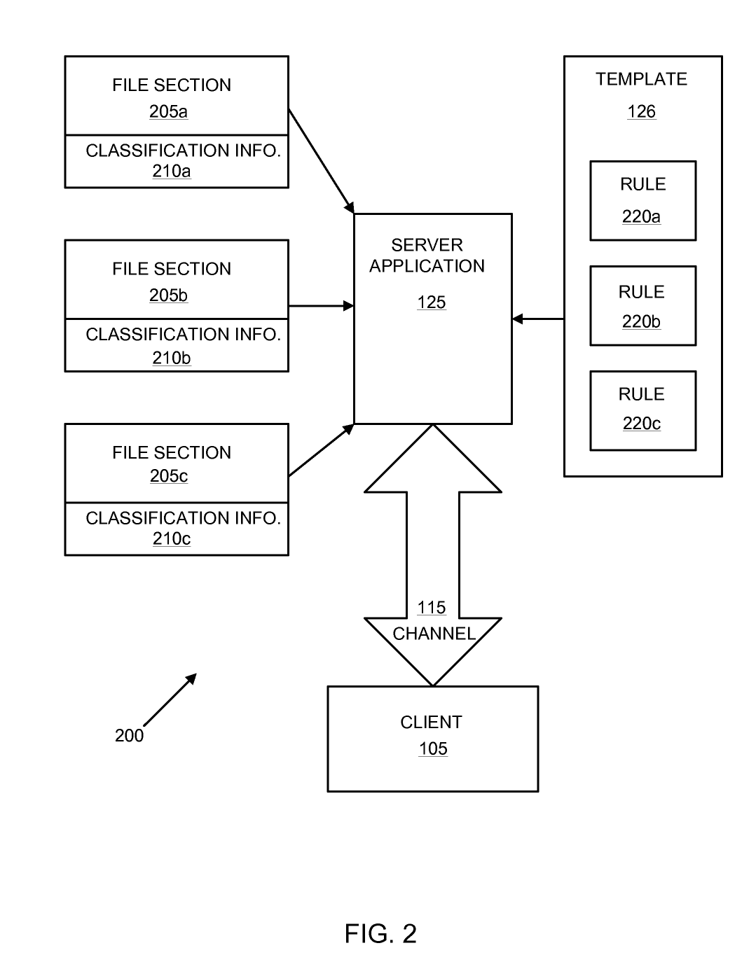

FIG. 2 is a functional overview diagram of one embodiment. A system 200 includes a server application 125 that transmits a file to a client 105 to service a request from the client 105. The channel 115 may facilitate operable communication between the server 120, which is running server application 125, and the client 105. Channel 115 may be a direct connection or a network. The network may be a public or a private network and may be a single network or a system of interconnected networks. The network may link the server 120 and client 105 by wire, wirelessly, via optical fiber, or by any suitable physical transmission media. As one example, the network may be the Internet. As another example, the network may be a private Ethernet network. In response to the request for the file from the client 105, the server application 125 accesses the file sections 205a, 205b, 205c (collectively referred to as 205), and the template 126.

In the present embodiment, each of the file sections 205a, 205b, and 205c may contain respective classification information 210a, 210b, and 210c (collectively referred to as 210). In another embodiment, the classification information may be found in the file header instead of with the individual file sections. In another embodiment, the classification information may be stored separate from the files sections, for example in a database or table accessible to the server 120. The classification information 210 may include information on the security level of the respective file sections 205. If the server application 125 finds that the file sections 205 have different security levels, it may use the accessed template 126 to determine a security protocol for the file sections 205. The template 126 may contain one or more rules. The illustrated embodiment shows, for example, three rules; rule 220a, rule 220b, and rule 220c (collectively referred to as 220). These rules 220 enable the server application to determine the security protocol for each of the file sections 205. For example, rule 220a may be a rule that requires any file section 205 that has a high security level to be sent using any 64 bit encryption method over channel 115. Another example may be a rule 220b that requires that file sections 205 with a low security level be combined and sent with a security protocol that has no encryption. One skilled in the art will appreciate that additional rules may incorporate any combination of encryption, compression, security requirements, channel requirements, and segmentation or bundling supported by the classification information 210, channel 115, server application 125, and client 105. Once the server application 125 determines the security protocol for the file sections 205, it may transmit the file sections 205 using the proper security protocol over channel 115 to the client 105.

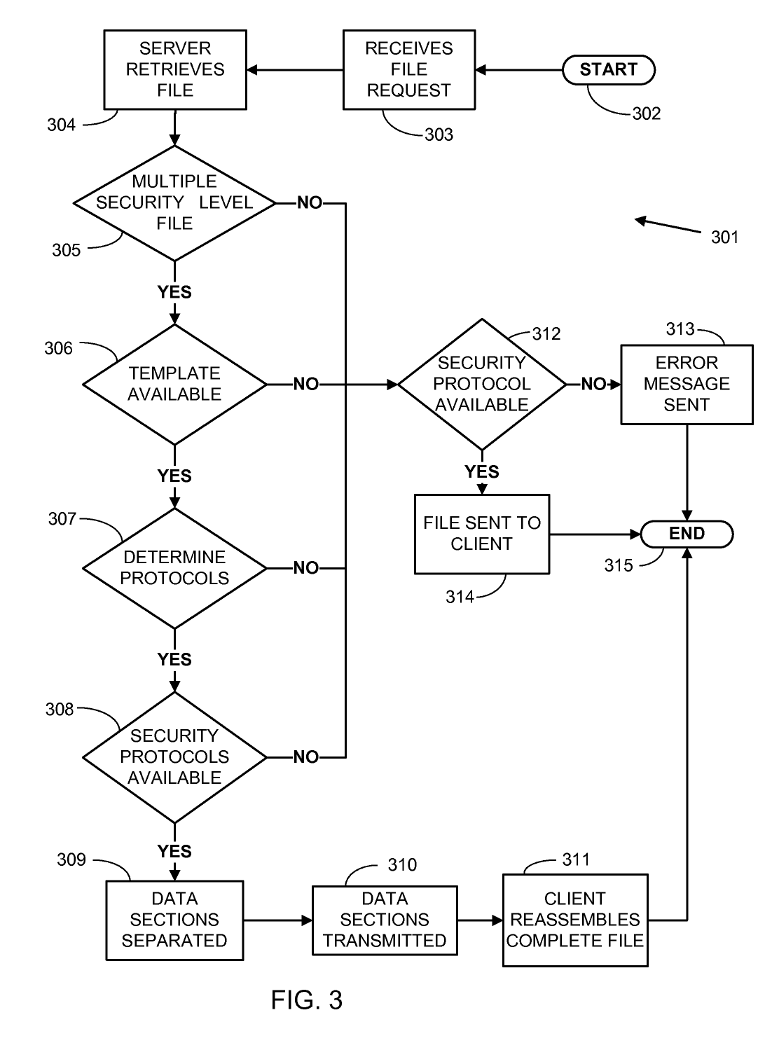

FIG. 3 is a flowchart of a method 301 to allow a file to be transferred between a server 120 and a client 105. In FIG. 3, method 301 begins at block 302. At block 303, the server 120 receives a file request from the client 105; the request may be made by a client application 110, or alternatively by software run or operated at the client. In block 304, the server 120 retrieves a file requested by the client 105 from storage. The file may either be retrieved by the server from local storage 124 or from storage that is remote from the server 120, such as a remote disk storage 135 or remote cloud storage 140, for example. In block 305, it is determined whether the file has sections with different security levels. The classification information may have information on the security level of each file section and be accessed by any means mentioned previously, such as within the meta-data for each file section 205 of the file. If the classification information 210 for the file sections are incomplete, unavailable, do not contain security level information, or do not show that the file sections 205 have different security levels, then the method may treat the answer to block 305 as “no” and proceed to block 312. In block 312, the server 120 determines whether there is a security protocol available that matches the security level requirement for the file. This security level may be provided by the file itself, the requesting client 105, client application 110, or in information about the file stored or accessible to the server 120. If there is not a security protocol available that meets the security level requirement, an error message is sent to the client 105 in block 313, and the process ends at block 315. If the proper security protocol is available for the file transfer, the server 120 may transmit the file using the proper security protocol to the client 105 in block 314, and the process is ended at block 315.

If the answer to block 305 is determined to be a “yes”, the method may determine at block 306 if there is a template 126 available for sectional transfer of the file. The template 126 may be available to the server 120, for example, stored within the local memory of the server 120. The template 126 may be provided by the client 105 with the file request or at any time prior to the transmission of the file from server 120 to client 105. The template 126 may provide information on methods of breaking the file into multiple sections and arranging these sections into groupings to be sent to the client 105. The template 126 may also specify a security protocol to use for transmitting each section of the file. The template 126 may, for example, set the security protocol based upon the security level of each of a file section 205, and may require that the file sections 205 be of a specific type or size, for example a chunk or a block. One of ordinary skill in the art may refer to a section of a file as a “chunk” and use the term “block” in conjunction with the term chunk. A block may be a portion of a file having a particular security level. The length of a block may vary according to the application. For a mixed security file, the security level for a file can be different for different blocks within the same file. In various embodiments, a chunk may include a set of one or more contiguous blocks having the same security level. The template 126 may, in some embodiments, be used by a specific client application 110, or may be integrated into security software used by the client 105 or the server 120. If no template 126 is found to be available in block 306, the method proceeds to block 312, continuing as previously described.

If the template 126 is found in block 306, the method may proceed to block 307. The classification information may be matched to the template 126 for breaking the file into sections and determining which security protocol should be used to transfer each data section to the client. The template 126 may, for example, set the security protocol based upon the security level of each file section 205. If the template 126 and the classification information 210 cannot be matched in a way that allows for the security protocol for the file sections 205 to be determined, for example, the template 126 requires classification information 210 at the chunk level and the classification information 210 cannot provide chunk level information, the method proceeds to block 312, continuing as previously described.

If the security protocols are determined to exist in block 307, the method may proceed to block 308. In block 308, the server 120 confirms that the channel 115 between the server 120 and the client 105 has, or is capable of, the security protocol for sectional transfer of the file based on the template 126 and classification information 210. Examples of security protocols are: SSL, PGP, S-HTTP, HTTPS, TLS, IPSec, and VPN. Authentication, authorization, confidentiality, and integrity are some of the variables the security protocol may use to measure the security of a channel 115 between a server 120 and client 105. These variables may be used in various combinations and ways by different security protocols. In various embodiments, different combinations of security protocol and channels may be used in transmission of the files sections 205 to the client 105. For example, the template 126 and classification 210 may result in two parts of connection endpoints, one with file sections 205a and 205b being sent using Secure Socket Layer, and the other file section 205c being sent with the Non-secure Socket Layer. If the channel 115 or encryption applications available between the server 120 and the client 105 do not provide the required security protocol determined by the template 126 and classification information 210, the method may treat the answer to block 308 as “no” then it proceeds to block 312, continuing as previously described.

If the required security protocols are found available in block 308, the method may proceed to block 309. In block 309, the data sections of the file are separated for transmission as outlined in the template. The data sections may be of any size supported by the template, classification information, and security protocols. In one embodiment, the server 120 may break the file down into sections for transmission from the server 120 to the client 105. In another embodiment, the template 126 may require the server 120 to break the file down into chunks having the similar security levels for grouping and then reassemble them into larger data chunks having the same security level for transmission based upon their similar required security protocol. In block 310, the server 120 transmits the data sections, as created in block 309, across the channel 115 using the proper security protocols previously determined. Multiple connections may be used. In block 311, the client 105 reassembles the data sections into a complete file if required. This may include decrypting and decompressing data sections that may have been encrypted for transmission in either block 309 or block 310 to meet the security protocol requirements. The reassembly may be done by the client application 110 requesting the file, security software or hardware used by the client 105, or by other applications available to the client 105 suitable for such a task. The method is then ended at block 315.

Exemplary embodiments have been described in the context of a fully functional system for sectional transfer of a file using different security protocol. Readers of skill in the art will recognize, however, that embodiments also may include a computer program product disposed upon computer-readable storage medium or media (or machine-readable storage medium or media) for use with any suitable data processing system or storage system. The computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer or storage system having suitable programming means will be capable of executing the steps of a method disclosed herein as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the claims.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be used. The computer readable medium may be a computer-readable signal medium or a computer-readable storage medium. The computer readable signal medium or a computer readable storage medium may be a non-transitory medium in an embodiment. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire, optical fiber cable, RF, etc., or any suitable combination of the foregoing.

Computer program code for carrying out operations for aspects may be written in any combination of one or more programming languages, including an object-oriented programming language such as Java, Smalltalk, C++ or the like and conventional procedural programming languages, such as the C programming language or similar programming languages. The program code may execute entirely on the user's computer, partly on the user's computer, as a stand-alone software package, or on one module or on two or more modules of a storage system. The program code may execute partly on a user's computer or one module and partly on a remote computer or another module, or entirely on the remote computer or server or other module. In the latter scenario, the remote computer other module may be connected to the user's computer through any type of network, including a local area network (LAN) or a wide area network (WAN), or the connection may be made to an external computer (for example, through the Internet using an Internet Service Provider).

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function or act specified in the flowchart, or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions or acts specified in the flowchart, or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terms “server and “client” are used herein for convenience only, and in various embodiments a computer system that operates as a client computer in one environment may operate as a server computer in another environment, and vice versa. The mechanisms and apparatus of embodiments of the present invention apply equally to any appropriate computing system, including a computer system that does not employ the client-server model.

While this disclosure has described the details of various embodiments shown in the drawings, these details are not intended to limit the scope of the invention as claimed in the appended claims.

What is claimed is:

1. A method comprising:
receiving a request from a client by a server for a file, the file having a first section having a first security level and a second section having a second security level;
determining a first security protocol for the first section of the file using a classification information and a template;
determining a second security protocol for the second section of the file using the classification information and the template;
transmitting the first section over a channel between the server and the client using the first security protocol; and
transmitting the second section over the channel between the server and the client using the second security protocol.

2. The method of claim 1, wherein the transmitting of the first and second sections of the file to the client using the template and classification information to determine the proper security layer is performed by a connection manager on the server.

3. The method of claim 1, wherein the classification information is contained in meta-data of the respective sections of the file.

4. The method of claim 1, wherein the classification information is contained in an extended attributes section of the file.

5. The method of claim 1, wherein the classification information is contained in a table maintained by a file server.

6. The method of claim 1, further comprising receiving the template by the server from the client.

7. An apparatus, comprising:
a storage to store a file, the file having a first section with a first security level and second section with a second security level, wherein each of the first and second file sections is associated with respective classification information;
a server adapted to transmit the file from the storage to a client using a first security protocol for the first file section and a second security protocol for the second file section, the first and second security protocols being selected based on a template and the respective associated classification information.

8. The apparatus of claim 7, wherein the storage resides on the server.

9. The apparatus of claim 7, wherein the storage resides remote from the server.

10. The apparatus of claim 7, further comprising a connection manager on the server to transmit the first and second sections of the file

11. The apparatus of claim 7, wherein the classification information is contained in a meta-data of the respective sections of the file.

12. The apparatus of claim 7, wherein the classification information is contained in an extended attributes section of the file.

13. The apparatus of claim 7, wherein the classification information is contained in a table maintained by a file server.

14. The apparatus of claim 7, further comprising the receiving of the template by the server from the client.

15. A non-transitory computer-readable storage medium having executable code stored thereon to cause a machine to perform a method for transferring a file, the method comprising:
receiving a request from a client by a server for a file, the file having a first section having a first security level and a second section having a second security level;
determining a first security protocol for the first section of the file using classification information and a template;
determining a second security protocol for the second section of the file using classification information and a template;
transmitting the first section over a channel between the server and the client using the first security protocol; and
transmitting the second section over the channel between the server and the client using the second security protocol.

16. The computer-readable storage medium of claim 15, wherein the transmitting of the first and second sections of the file to the client using the template and classification information to determine the proper security layer is performed by a connection manager on the server.

17. The computer-readable storage medium of claim 15, wherein the classification information is contained in a meta-data of the respective sections of the file.

18. The computer-readable storage medium of claim 15, wherein the classification information is contained in an extended attributes section of the file.

19. The computer-readable storage medium of claim 15, wherein the classification information is contained in a table maintained by a file server.

20. The computer-readable storage medium of claim 15, further comprising the receiving of the template by the server from the requesting client.
